(19) United States
(12) Patent Application Publication
(10) Pub. No.: US 2008/0044033 A1
(43) Pub. Date: Feb. 21, 2008

(54) Sound pickup device and sound pickup method

(75) Inventor: Kazuhiko Ozawa, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/889,359

(22) Filed: Aug. 13, 2007

(30) Foreign Application Priority Data
Aug. 21, 2006 (JP) 2006-224526

(51) Int. Cl. H04R 5/00

(52) U.S. Cl. 381/26

(57) ABSTRACT

A sound-pickup device includes an input unit configured to input a plurality of sound signals, a sound-directivity-generation unit configured to generate a plurality of sound-directional signals in all circumferential directions from the sound signals, a scanning unit configured to scan and output the sound-directional signals in order of directivity directions, and a vector-synthesis unit configured to select at least one specified-direction signal transmitted from the scanning unit and synthesize a specified direction. At least one signal output from the vector-synthesis unit is processed to be a plurality of sound-output channels.

### CROSS REFERENCES TO RELATED APPLICATIONS

The present invention contains subject matter related to Japanese Patent Application JP 2006-224526 filed in the Japanese Patent Office on Aug. 21, 2006, the entire contents of which are incorporated herein by reference.

### BACKGROUND OF THE INVENTION

1. Field of the Invention

The present invention relates to a sound-pickup device and a sound-pickup method.

2. Description of the Related Art

In recent years, a sound signal recorded by using a multi-channel-sound system is reproduced through a plurality of speakers in households. Subsequently, it becomes possible to obtain the same surround effects as those obtained in movie theaters where sound signals are now usually reproduced by using the multi-channel-sound system. Therefore, products and broadcast technologies ready for the multi-channel reproduction are now commercially introduced from many fields. Although a 5.1ch-surround system is the most widespread surround system at present, products ready for a 6.1ch-surround system, a 7.1ch-surround system, and so forth are also put into commercial production, so as to increase the surround effects.

First, an example where sound-pickup processing is performed by using the 5.1ch-surround system will be described with reference to FIG. 18. The 5.1ch-surround system is widely available, as a multi-channel-surround system. The term “5.1ch” indicates 5 channels including a forward direction (directional pattern 1), a left-front direction (directional pattern 2), a right-front direction (directional pattern 3), a left-rear direction (directional pattern 4), and a right-rear direction (directional pattern 5), and a 0.1 channel including an omnidirectional direction (directional pattern 6). The above-described directions are determined with reference to a photographer and/or a viewer.

Each of the directional patterns 1 to 6 has the magnitude (sound-pickup level) in each of directions. Hereinafter, therefore, the above-described directional directions are referred to as a front (FRT) vector, a front-left (FL) vector, a front right (FR) vector, a rear-left (RL) vector, a rear-right (RR) vector, and a low-frequency (LF) scalar in that order. Here, the LF scalar is provided to obtain the massive feeling of a bass sound generated at a frequency of about 100 Hz or less. Since the wavelength of the directional pattern 6 is long, the directional pattern 6 is hardly directional and can be measured only by its magnitude. Therefore, the directional pattern 6 is treated, as a scalar quantity on purpose.

An example surround-sound-reproduction device provided to reproduce sound signals captured from the above-described directions is shown in FIG. 19. Namely, the sound signals and signals of video shot by using a known surround-capable system are reproduced at the same time, whereby a surround-sound field can be obtained. Sound-pickup processing and/or sound-source-generation processing performed in the above-described surround-sound field can be performed in various ways according to the productive purpose and/or know-how of a producer. However, the international-telecommunication-union (ITU)-R standard had been introduced, as the 5.1ch-sound-field-reproduction standard, so that reproduction speakers are arranged in the following manner. Namely, it is preferable that the center (FRT) direction is determined to be 0°, the front-L (FL) direction is determined to be 300, the front-R (FR) direction is determined to be 30°, the rear-L (RL) direction is determined to be from 100° to 120°, and the rear-R (RR) direction is determined to be from 100° to 120°. Subsequently, the above-described sound-pickup processing and/or sound-source-generation processing is often performed for the above-described reproduction-sound field.

Japanese Unexamined Patent Application Publication No. 2000-299842 proposes a video camera configured to pick up sound signals transmitted from a specified direction in sound-field space by using a plurality of microphones, and record and reproduce the sound signals by using a multi-channel-sound system. Particularly, in recent years, digital versatile disk (DVD)-capable devices have become widely available, and it becomes easier to reproduce a sound signal in a 5.1ch-surround-sound field or the like than before. Therefore, the market share of the video camera disclosed in Japanese Unexamined Patent Application Publication No. 2000-299842 increases, where the video camera is provided to allow a user to record and/or reproduce a sound signal by using the multi-channel-sound system.

However, most of usual surround sound fields enjoyed by users are produced along with video such as a movie.

Therefore, authoring processing disclosed in Japanese Unexamined Patent Application Publication No. 2006-25034 is often performed by a producer, so as to insert an effective sound on purpose according to video. Therefore, a user accustomed to the above-described surround sounds could not be amazed by a video camera that only records and/or reproduces multi-channel signals simply captured from the sound-field directions.

### SUMMARY OF THE INVENTION

However, the technologies disclosed in Japanese Unexamined Patent Application Publication No. 2000-299842 and Japanese Unexamined Patent Application Publication No. 2006-25034 have the following problems.

1. Since the sound-pickup direction of each of the channels is fixed at all times, sound signals picked up from the sound-pickup direction do not often satisfy sound-field conditions at the video-shooting time. For example, the sound-field conditions of the case where a subject is a child ahead of a photographer and voice generated by the child is the main sound source are different from those of the case where at least two sound sources are distributed over a wide area, as is the case with a theme park. In that case, it is preferable that each of the sound-pickup directions be optimized.

2. A sound-field disagreement occurs due to a difference between record conditions determined based on directions from which a sound is picked up by using a video camera or the like and/or the number of channels, for example, and reproduction conditions determined based on the positions where a plurality of speaker devices are arranged at the reproduction time, for example.

3. The surround-sound effect reproduced for ordinary screened movies and/or DVD software is subjected to effective authoring editing according to produced video.

Namely, most of sounds reproduced for the movies and/or the DVD software is not captured at the video-shooting site. Therefore, in many cases, a user accustomed to the above-described surround-sound effects would not be satisfied by surround effects obtained simply by reproducing sound signals recorded through a multi-channel-sound system by using a plurality of speakers.

Therefore, according to an embodiment of the present invention, when a multi-channel signal is generated for obtaining the above-described surround-sound effects in the sound-pickup operation, sound-pickup processing is performed a number of times larger than the number of reproduction channels in the circumferential directions corresponding to from 1 degree to 360 degrees, and data on the picked-up sounds is edited, as intended, according to the sound-field state and images at the video-shooting time. Subsequently, an effective surround-sound field can be obtained.

A sound-pickup device according to an embodiment of the present invention includes an input unit configured to input a plurality of sound signals, a sound-directivity-generation unit configured to generate a plurality of sound-directional signals in all circumferential directions from the sound signals, a scanning unit configured to scan and output the sound-directional signals in order of directivity directions, and a vector-synthesis unit configured to select at least one specified-direction signal transmitted from the scanning unit and synthesize a specified direction, wherein at least one signal output from the vector-synthesis unit is processed to be a plurality of sound-output channels.

A sound-pickup device according to another embodiment of the present invention includes an input unit configured to input a plurality of sound signals relating to a signal of shot video, a sound-directivity-generation unit configured to generate a plurality of sound-directional signals in all circumferential directions from the sound signals, a scanning unit configured to scan and output the sound-directional signals in order of directivity directions, and a vector-synthesis unit configured to select at least one specified-direction signal transmitted from the scanning unit and synthesize a specified direction, wherein at least one signal output from the vector-synthesis unit is processed to be a plurality of sound-output channels.

A sound-pickup device according to another embodiment of the present invention includes a reproduction unit configured to reproduce a plurality of sound-directional signals, a scanning unit configured to scan and output the sound-directional signals in order of directivity directions, and a vector-synthesis unit configured to select at least one specified-direction signal transmitted from the scanning unit and synthesize a specified direction, wherein at least one signal output from the vector-synthesis unit is processed to be a plurality of sound-output channels.

According to an embodiment of the present invention, when a multi-channel signal is generated for obtaining the above-described surround-sound effects in the sound-pickup operation, sound-pickup processing is performed a number of times larger than the number of reproduction channels in the circumferential directions corresponding to from 1 degree to 360 degrees, and data on the picked-up sound is edited, as intended, according to the sound-field state and images at the video-shooting time. Subsequently, an effective surround-sound field can be obtained.

An embodiment of the present invention can be applied to the case where a sound signal is picked up and recorded along with video data captured by a video camera or the like.

An embodiment of the present invention can be performed not only in the sound-pickup operation and/or the sound-recording operation, but also in the operation where the sound data is reproduced from a recording-and-reproduction device. In that case, the sound data can be reproduced in the most appropriate manner for the reproduction conditions. Namely, the sound data can be reproduced according to the speaker-arrangement directions, for example.

### BRIEF DESCRIPTION OF THE DRAWINGS

FIG. 1 shows the configuration of a sound-pickup device according to an embodiment of the present invention;

FIG. 2A illustrates a sound-directional characteristic according to an embodiment of the present invention;

FIG. 2B illustrates another sound-directional characteristic according to an embodiment of the present invention;

FIG. 2C illustrates another sound-directional characteristic according to an embodiment of the present invention;

FIG. 2D illustrates another sound-directional characteristic according to an embodiment of the present invention;

FIG. 2E illustrates another sound-directional characteristic according to an embodiment of the present invention;

FIG. 3A shows an example microphone arrangement according to an embodiment of the present invention;

FIG. 3B shows another example microphone arrangement according to an embodiment of the present invention;

FIG. 3C shows another example microphone arrangement according to an embodiment of the present invention;

FIG. 4A shows an example directivity-generation device;

FIG. 4B is a diagram describing the directivity-generation device shown in FIG. 4A;

FIG. 4C is another diagram describing the directivity-generation device shown in FIG. 4A;

FIG. 5 is a diagram describing an embodiment of the present invention;

FIG. 6A shows another example directivity-generation device;

FIG. 6B is a diagram describing the directivity-generation device shown in FIG. 6A;

FIG. 6C is another diagram describing the directivity-generation device shown in FIG. 6A;

FIG. 7 shows example directional-stream signals;

FIG. 8 is a diagram describing an embodiment of the present invention;

FIG. 9 is a diagram describing an embodiment of the present invention;

FIG. 10 shows the configuration of an example device configured to perform directivity-generation processing and up-sampling processing;

FIG. 11 shows the configuration of an example vector-synthesis section;

FIG. 12 is a diagram describing an embodiment of the present invention;

FIG. 13 is a diagram describing an embodiment of the present invention;

FIG. 14 shows the configuration of another example vector-synthesis section;

FIG. 15 is a diagram describing an embodiment of the present invention;

FIG. 16 shows the configuration of another example vector-synthesis section;

FIG. 17 is a diagram describing an embodiment of the present invention;

FIG. 18 shows diagrams illustrating example surround-sound-pickup processing; and

FIG. 19 is a diagram showing an example surround-sound-reproduction system.

### DESCRIPTION OF THE PREFERRED EMBODIMENTS

Hereinafter, a sound-pickup device and a sound-pickup method according to an embodiment of the present invention will be described with reference to the attached drawings.

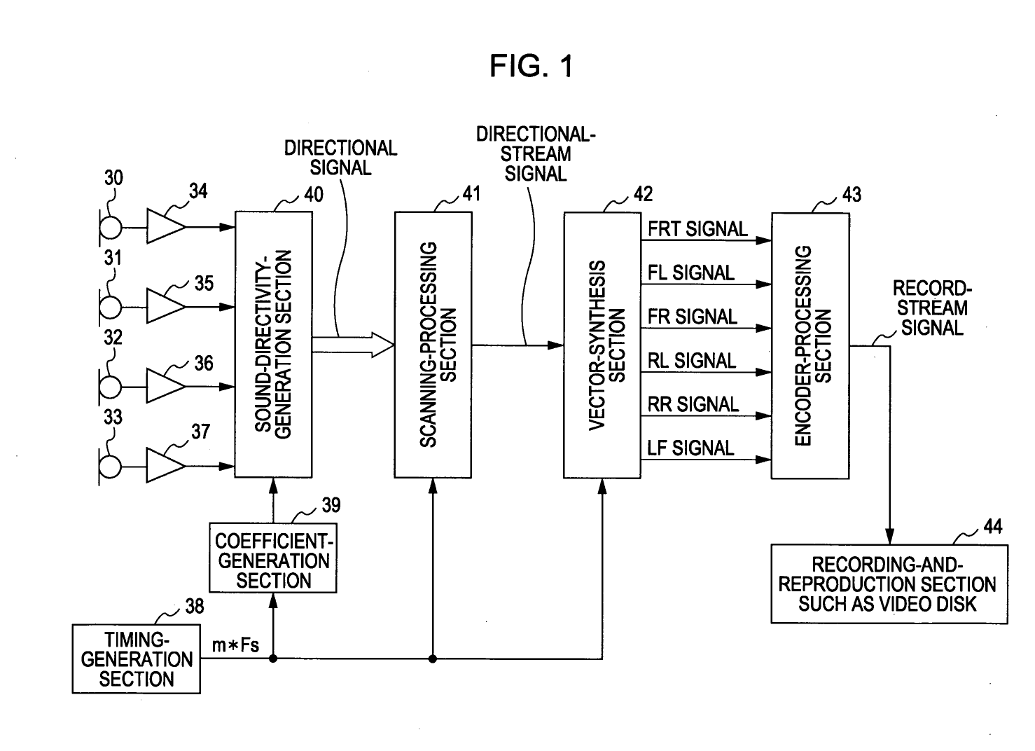

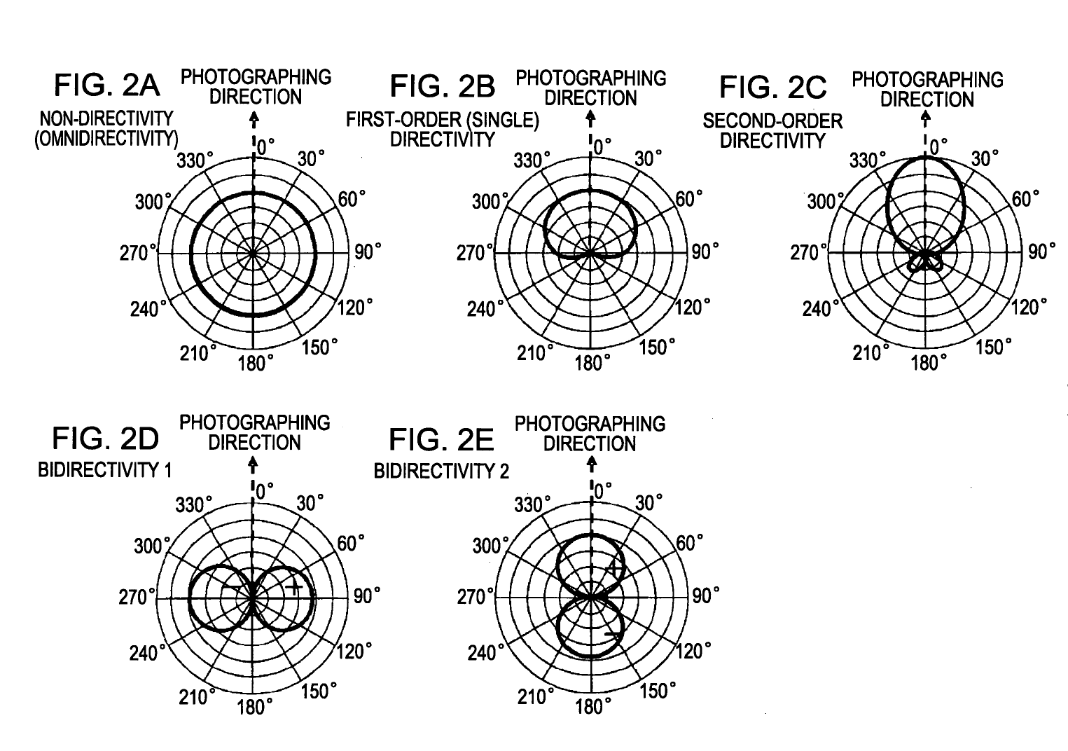

For describing the above-described sound-pickup device shown in FIG. 1, polar patterns generated in various types of microphone units are shown and illustrated in FIGS. 2A, 2B, 2C, 2D, and 2E. The polar pattern is sensitivity levels of each of the microphone units from all-circumferential directions, the sensitivity levels being shown according to a polar-coordinate-display method. In each of FIGS. 2A, 2B, 2C, 2D, and 2E, the photographing direction of a video camera is determined to be 0°, the sensitivity level in the radius direction is relatively determined, and the center point is determined to be a zero-sensitivity point.

FIG. 2A shows a non-directivity (omnidirectivity) having sensitivity characteristics of the same level in all directions. FIG. 2B shows a first-order (single) directivity which is often used, so as to provide directivity in a single direction. In that case, the directivity is provided in the 0° direction. FIG. 2C shows a second-order directivity having a direction-selection characteristic larger than that of the first-order directivity.

Each of FIGS. 2D and 2E shows a bidirectivity having the maximum sensitivities in a predetermined direction and a direction opposite thereto, and shows the zero sensitivity in the 90° direction. The bidirectivity shown in FIG. 2D is perpendicular to that shown in FIG. 2E. Further, the “+” characteristics are opposed to the “−” characteristics and the signal phase of the “+” characteristics and that of the “−” characteristics are shifted from each other by as much as 180°. Then, the above-described directional characteristics can be generated by using a single microphone unit and/or combining a small number of microphone units.

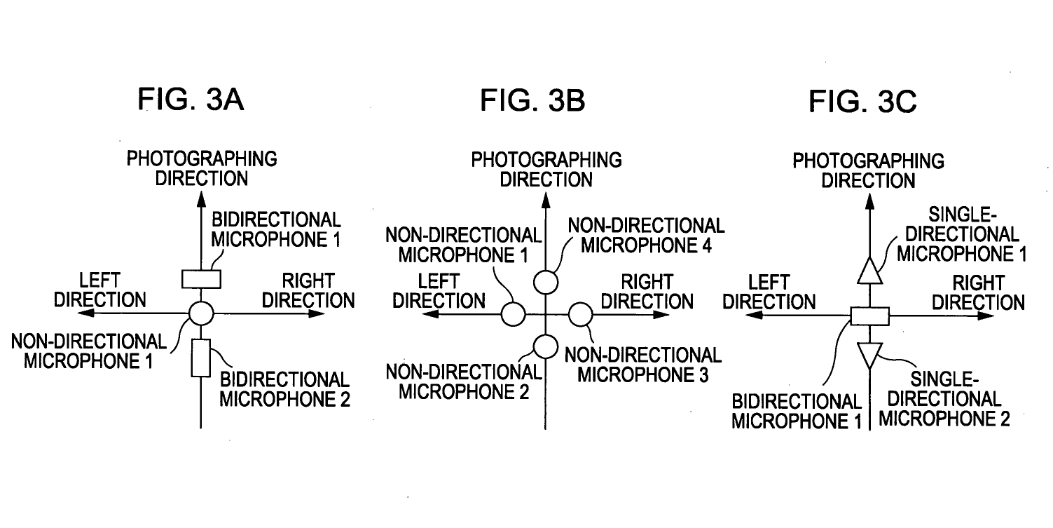

Here, an example arrangement of microphones will be described with reference to FIG. 3. In that case, each of the above-described microphones can be added to a small device including a video camera, a digital camera, and so forth internally and/or externally so that the microphone arrangement is achieved. In FIGS. 3A, 3B, and 3C, a non-directional microphone is indicated by the sign of ◯, a bidirectional microphone is indicated by the sign of □, where the bidirectional microphone has directivity in a longitudinal direction, and a single-directional microphone is indicated by the sign of Δ, where the single-directional microphone has directivity in an acute-angle direction. The above-described microphones are installed onto the top face of a video camera or the like. In FIGS. 3A, 3B, and 3C, the above-described microphones are viewed from an upper direction.

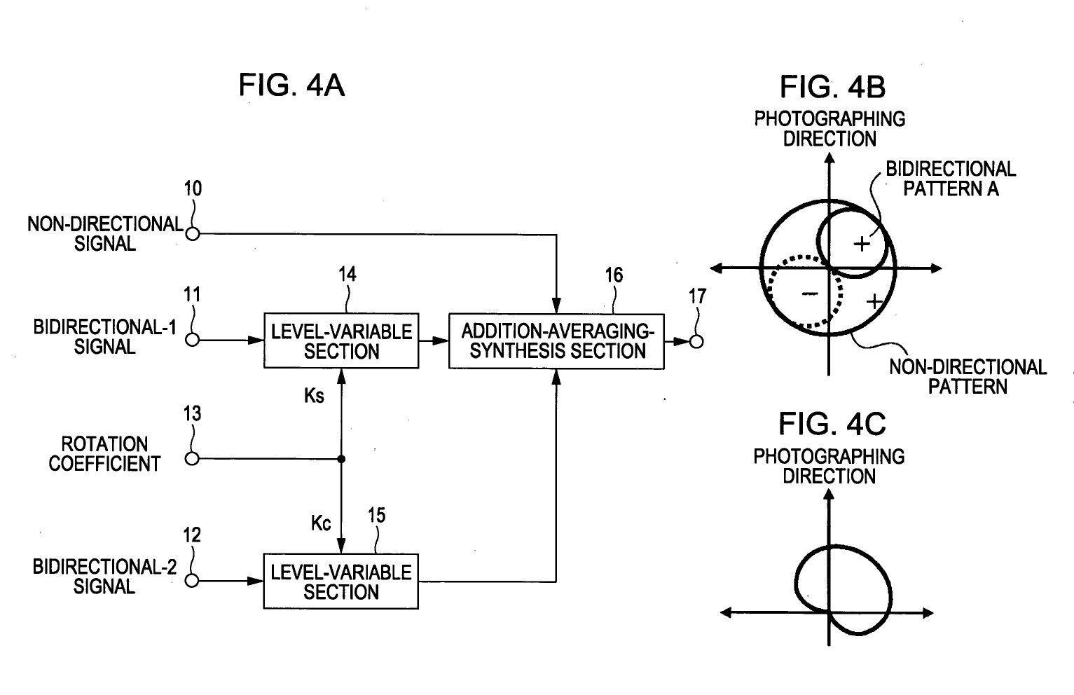

First, FIG. 3A shows a non-directional microphone 1, and bidirectional microphones 1 and 2. FIG. 4A illustrates an example directivity-generation device 1 using the non-directional microphone 1 and the bidirectional microphones 1 and 2. The non-directional signal corresponding to the non-directivity shown in FIG. 2A, where the non-directional signal is generated by the non-directional microphone 1, is input from an input end 10, the bidirectional-1 signal corresponding to the bidirectivity shown in FIG. 2D, where the bidirectional-1 signal is generated by the bidirectional microphone 1, is input from an input end 11, and the bidirectional-2 signal corresponding to the bidirectivity shown in FIG. 2E, where the bidirectional-2 signal is generated by the bidirectional microphone 2, is input from an input end 12.

Then, the bidirectional-1 signal is input to an addition-averaging-synthesis section 16 via a level-variable section 14, the bidirectional-2 signal is input to the addition-averaging-synthesis section 16 via a level-variable section 15, as is the case with the bidirectional-1 signal, and both the bidirectional-1 signal and the bidirectional-2 signal are subjected to addition-averaging processing. At that time, each of the bidirectional-1 signal and the bidirectional-2 signal is multiplied by a rotation coefficient transmitted from the input end 13 in each of the level-variable sections 14 and 15, where the rotation coefficient will be described later. Subsequently, the directional axis of a synthesized bidirectional signal can be rotated in any of the directions corresponding to from 1 degree to 360 degrees.

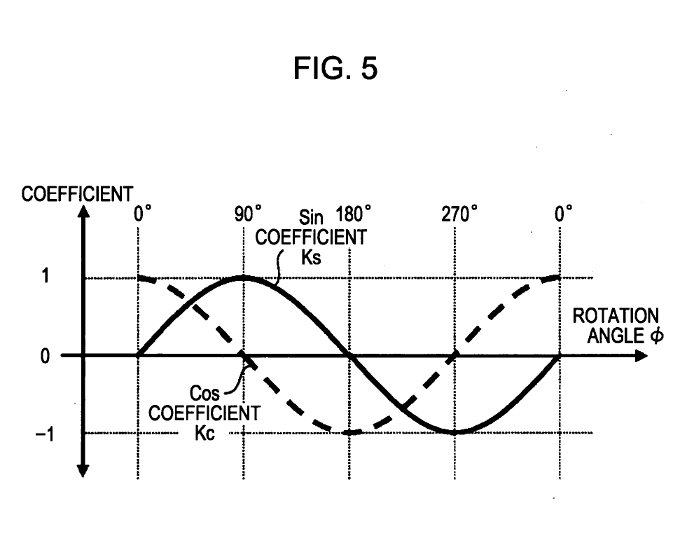

FIG. 5 shows an example generated rotation coefficient. Here, the horizontal axis shows a rotation angle φ and the vertical axis shows the coefficient value. The solid line shown in FIG. 5 indicates a Sin coefficient Ks by which the bidirectional-1 signal is multiplied in the level-variable section 14, and the broken line shown in FIG. 5 indicates a Cos coefficient Kc by which the bidirectional-2 signal is multiplied in the level-variable section 15. When the rotation angle φ is 0°, the coefficients are Ks=0 and Kc=1 so that only the bidirectional-2 signal is input to the addition-averaging-synthesis section 16. When the rotation angle φ is 45°, the level ratio is of Ks=0.7 to Kc=0.7 so that the bidirectional-1 signal and the bidirectional-2 signal are added to each other in the addition-averaging-synthesis section 16 and output, as bidirectivity pattern A shown in FIG. 4B. Further, when the rotation angle φ is 90°, only the bidirectional-1 signal is input to the addition-averaging-synthesis section 16.

Still further, when the rotation angle φ is from 90° to 180°, the Cos coefficient Kc becomes a negative coefficient by which the bidirectional-2 signal is multiplied. Subsequently, the bidirectional-2 signal is synthesized with and the positive/negative polarity thereof is inverted. When the rotation angle φ is from 180° to 270°, the Sin coefficient Ks and the Cos coefficient Kc become negative coefficients by which the bidirectional-1 signal and the bidirectional-2 signal are multiplied. Subsequently, the bidirectional-1 signal and the bidirectional-2 signal are synthesized and the positive/negative polarities thereof are inverted. When the rotation angle φ is from 270° to 0°, the Sin coefficient Ks becomes a negative coefficient by which the bidirectional-1 signal is multiplied. Subsequently, the bidirectional-1 signal is synthesized with and the positive/negative polarity thereof is inverted.

Subsequently, when the rotation coefficient shown in FIG. 5 is transmitted continuously and repeatedly, the bidirectional pattern is rotated continuously. Further, when the bidirectional signal and a non-directional signal input from the input end 10 are subjected to the addition-averaging processing in the addition-averaging-synthesis section 16, the following result is obtained, for example. Namely, according to the bidirectional pattern A shown in FIG. 4B, a reverse-phase part indicated by a broken line is cancelled, a same-phase part indicated by a solid line remains, and a single-directional pattern shown in FIG. 4C is generated.

Subsequently, a single-directional signal synchronized with the rotation of the bidirectional pattern is output from an output end 17. The operational expression of a directivity generated at that time is shown, as Equation (1).

(1+Ks·Sin θ+Kc·Cos θ)/2 (1)

In Equation (1), 1 denotes the characteristic of the non-directivity shown in FIG. 2A, Sin θ denotes the characteristic of the bidirectivity 1 shown in FIG. 2D, and Cos θ denotes the characteristic of the bidirectivity 2 shown in FIG. 2E.

The directivity can be varied even though non-directional microphones 1, 2, 3, and 4 are used, as is the case with FIG. 3B. Namely, when the frequency-amplitude characteristic is adjusted by subtracting the non-directional microphone 1 from the non-directional microphone 3, the bidirectional-1 signal is generated. When the frequency-amplitude characteristic is adjusted by subtracting the non-directional microphone 2 from the non-directional microphone 4, the bidirectional-2 signal is generated. Further, when any of the non-directional microphones 1 to 4 is used alone and/or at least two of the non-directional microphones 1 to 4 are added to each other, a non-directional signal is generated. Therefore, the directivity can be varied continuously, as is the case with FIG. 4.

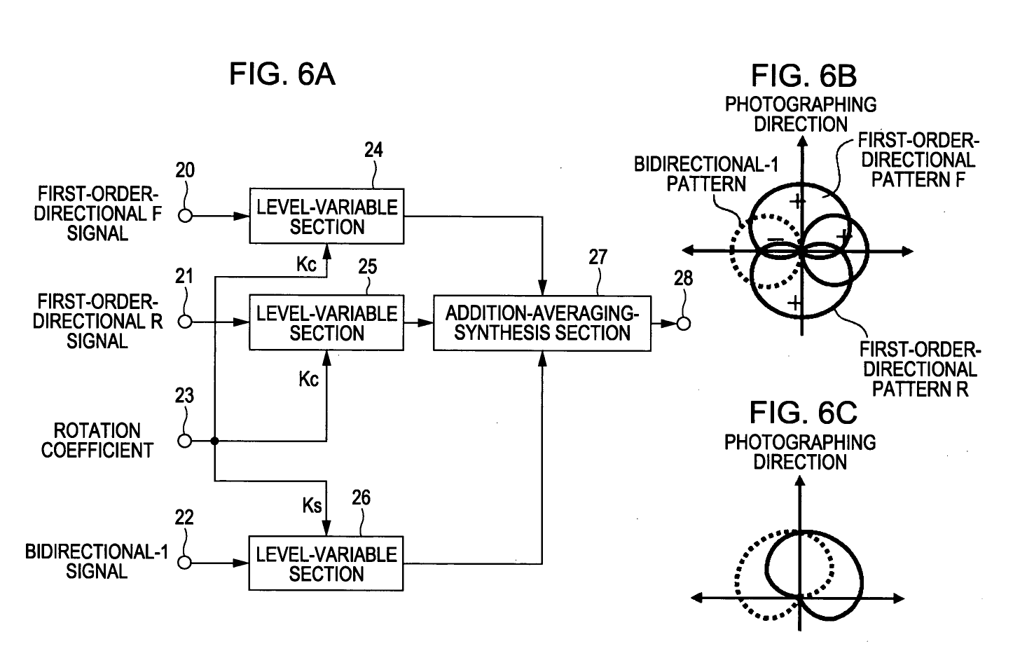

FIG. 6A illustrates an example directivity-generation device 2 using the single-directional-microphones 1 and 2, and the bidirectional microphone 1 that are shown in FIG. 3C. First, the first-order-directional-F signal corresponding to a first-order-directional pattern F shown in FIG. 6B is input from an input end 20, the first-order-directional-F signal being generated by the single-directional microphone 1. Then, the first-order-directional-R signal corresponding to a first-order-directional pattern R shown in FIG. 6B is input from an input end 21, the first-order-directional-R signal being generated by the single-directional microphone 2.

Here, the first-order-directional pattern F has the same characteristics as those of the first-order (single) directivity shown in FIG. 2B and the first-order-directional pattern R is a first-order-directional pattern having the main axis oriented to the 180° direction. Further, the bidirectional-1 signal shown in FIG. 2D is input from an input end 22, the bidirectional-1 signal being generated by the bidirectional microphone 1. Then, the input signals are input to level-variable sections 24, 25, and 26, and the level-variable sections 24 to 26 are controlled to a predetermined level due to the above-described rotation coefficients Kc and Ks input from an input end 23. Further, outputs from the level-variable sections 24 to 26 are synthesized in an addition-and-averaging-synthesis section 27, and output from an output end 28.

The operational expression of a directivity generated at that time is shown, as Equation (2).

((1+Kc)·(1+Cos θ)/2+(1−Kc)·(1−Cos θ)/2+Ks·Sin θ)/2 (2)

In Equation (2), (1+Cos θ)/2 denotes the first-order-directional characteristic F shown in FIG. 6B, (1−Cos θ)/2 denotes the first-order-directional characteristic R shown in FIG. 6B, and Sin θ denotes the bidirectional-1 characteristic shown in FIG. 6B.

Namely, when the rotation angle φ is 0°, the coefficients are Ks=0 and Kc=1 so that only the first-order-directional-F signal is output from the level-variable section 24 and output from the output end 28. When the rotation angle φ is 45°, the level ratio is of Ks=0.7 to Kc=0.7 so that the signals are added by the addition-averaging-synthesis section 27, and the single directivity is generated in a 45° direction, as shown by the solid line shown in FIG. 6C. Similarly, when the rotation angle φ is 90°, a non-directional signal is generated from the first-order-directional-F signal and the first-order-directional-R signal. Further, when addition-and-averaging processing is performed for the generated non-directional signal and the bidirectional-1 signal, single directivity is generated in a 90° direction.

Further, the synthesis is carried out by the Cos coefficient Kc as a negative coefficient, when the rotation angle φ is from 90° to 180°, the synthesis is carried out by the Sin coefficient Ks and the Cos coefficient Kc as negative coefficients, when the rotation angle φ is from 180° to 270°, and the synthesis is carried out by the Sin coefficient Ks as a negative coefficient, when the rotation angle φ is from 270° to 0°. Incidentally, when the rotation angle φ is 135°, a single directivity is generated in a 135° direction, as shown by a broken line shown in FIG. 6C. Therefore, a single-directional signal synchronized with the rotation angle φ is output from the output end 28. Here, in Equation (2), (1+Cos θ)/2 denotes a single-directional-microphone-1 signal and (1−Cos θ)/2 denotes a single-directional-microphone-2 signal.

Further, according to the above-described embodiment, the single directivity is used, as shown in FIGS. 4A, 4B, 4C, 6A, 6B, and 6C. However, the directivity can be varied according to second-order directivity shown in FIG. 2C. An example operational expression of the above-described directivity is shown, as Equation (3):

((1+Ks·Sin θ+Kc·Cos θ)·(Ks·Sin θ+Kc·Cos θ))/2 (3).

In Equation (3), 1 denotes the characteristic of the non-directivity shown in FIG. 2A, Sin θ denotes the characteristic of the bidirectivity 1 shown in FIG. 2D, and Cos θ denotes the characteristic of the bidirectivity 2 shown in FIG. 2E.

In that case, since the angle of the directivity can be narrowed, the selectivity of each of directional signals increases during directivity-scanning processing which will be described later.

Further, since the microphone arrangement shown in each of FIGS. 3A to 3C is an example, the microphone arrangement can be varied without leaving the scope of the above-described embodiment, as long as the microphones are relatively close to one another.

A plurality of directional signals transmitted from the all-circumferential directions, the directional signals being generated in the above-described manner, may be processed on a direction-by-direction basis. In that case, however, the processing tends to become extensive and complicated due to an increased number of channels to be handled. According to an embodiment of the present invention, therefore, each of the directional signals is handled, as a stream signal of a single channel and/or a small number of channels.

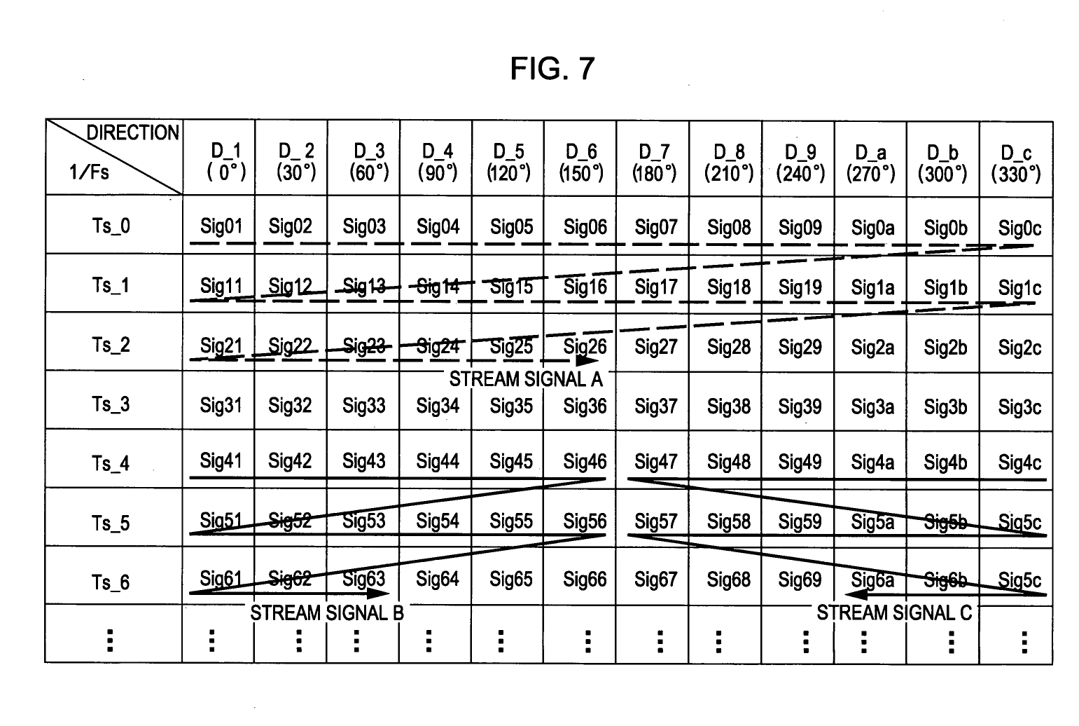

Here, a directional-stream signal will be described with reference to a matrix table shown in FIG. 7. First, D_{—}1, D_{—}2, D_{—}3, D_{—}4, D_{—}5, D_{—}6, D_{—}7, D_{—}8, D_{—}9, D_a, D_b, and D_c shown on the horizontal axis denote directional channels obtained by dividing the circumference by 30°. Further, each of Ts_{—}0, Ts_{—}1, Ts_{—}2, Ts_{—}3, Ts_{—}4, Ts_{—}5, Ts_{—}6, and so forth shown along the vertical axis of the matrix table shown in FIG. 7 is an example audio-sampling period (1/Fs). Then, when the sampling period Ts_{—}0 is arbitrarily selected, sound signals sampled in order of ascending direction, namely, the D_{—}1 direction, the D_{—}2 direction, the D_{—}3 direction, and so forth are shown, as Sig01, Sig02, Sig03, Sig04, Sig05, Sig06, Sig07, Sig08, Sig09, Sig0a, Sig0b, and Sig0c. Further, when the next sampling period Ts_1 is selected, the sound signals are shown, as Sig11, Sig12, Sig13, Sig14, Sig15, Sig16, Sig17, Sig18, Sig19, Sig1a, Sig1b, and Sig1c.

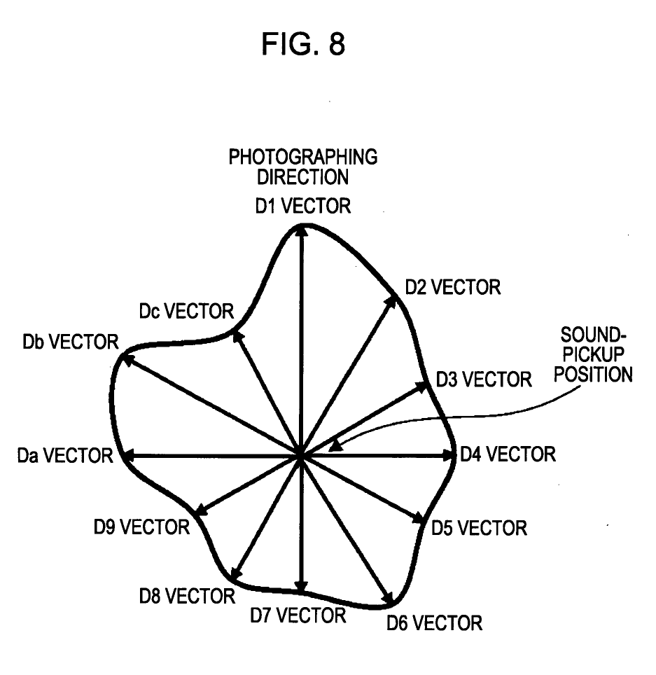

Further, the sampling signals transmitted from the above-described directions, the sampling signals being obtained when the above-described sampling periods are selected, are scanned in a zigzag manner, whereby a single sound-stream signal is generated, as shown by a stream signal A indicated by a broken line. The sound signal includes the time base and the level of a vector component having a direction. The above-described configuration is shown by extracted vector amounts shown in FIG. 8. Namely, a directional pattern generated in the above-described manner can be considered, as an aggregation of vector amounts having the maximum intensities in the directivity-center directions. When the vector-amount aggregation is scanned in the direction of its main axis, as shown in FIG. 7, the vector amount corresponding to the sound-pickup level can be obtained with reference to each of the main-axis directions. The above-described vector amount can be obtained every audio-sampling period, as shown in FIG. 8, for example.

According to the above-described embodiment, without being limited to the above-described scanning method, directional components may be divided into two groups and scanned in the zigzag manner so that two sound-stream signals are generated, as is the case with stream signals B and C indicated by solid lines. Further, the directional components may be divided into at least three groups.

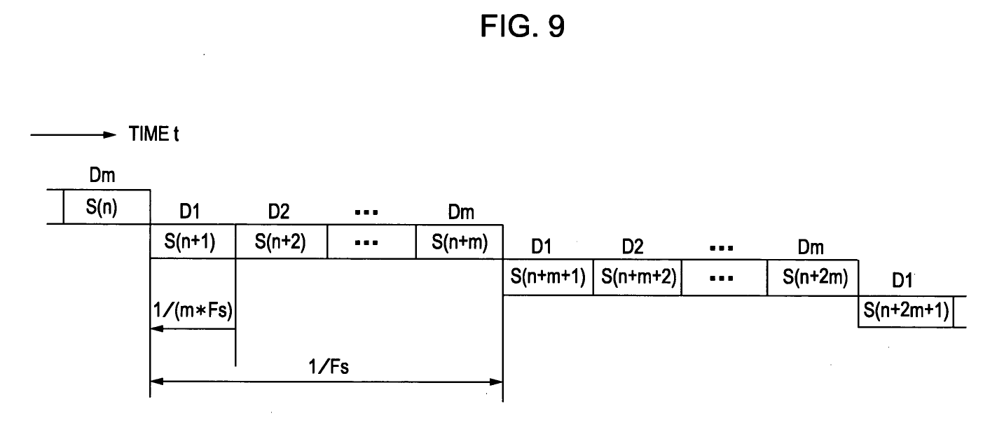

Usually, when directional signals are generated in 1 to m directions by performing scanning for an audio-sampling frequency Fs, the sampling period of a necessary stream signal is shown, as 1/(m·Fs), as shown in FIG. 9.

Next, the sound-pickup device according to the above-described embodiment, the sound-pickup device being shown in FIG. 1, will be described. Microphones 30, 31, 32, and 33 are the non-directional microphones 1 to 4 shown in FIG. 3B, for example. Output signals transmitted from the microphones 30 to 33 are input to a sound-directivity-generation section 40 illustrated in FIGS. 4A, 4B, 4C, 6A, 6B, and 6C via amplifiers (AMP) 34, 35, 36, and 37, and a group of signals in directional directions is generated due to a rotation coefficient transmitted from a coefficient-generation section 39. Then, a directional-stream signal is generated through the scanning processing that is shown in FIG. 7 and that is performed by a scanning-processing section 41, and the directional-stream signal is input to a vector-synthesis section 42.

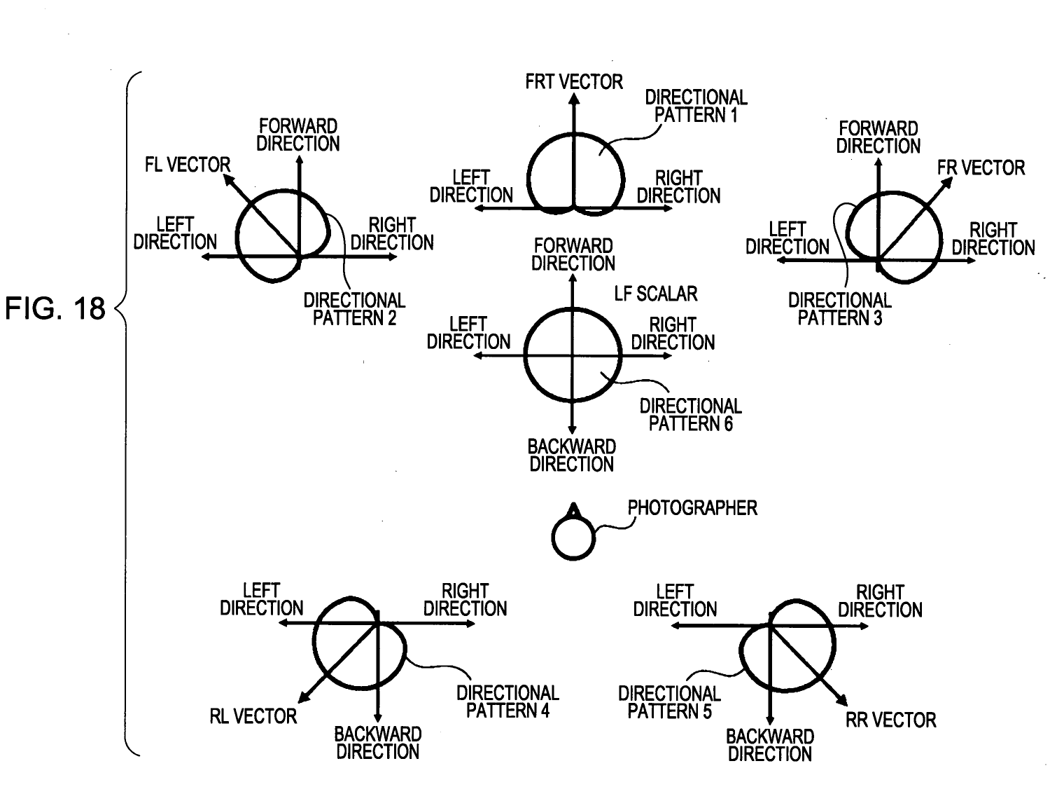

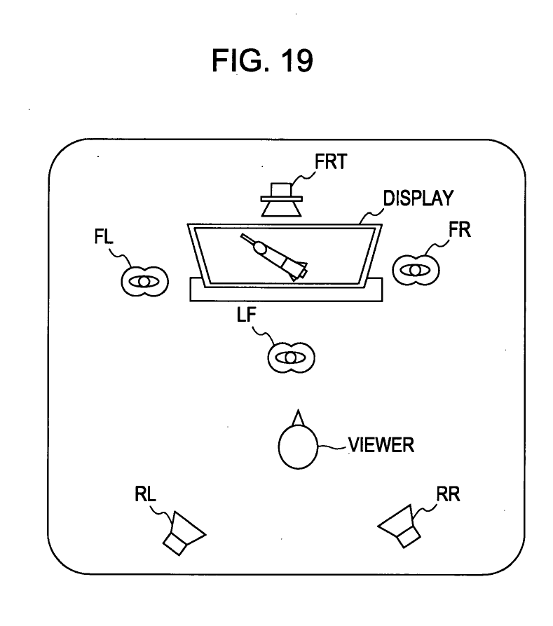

Further, according to the above-described sample-period information transmitted from a timing-generation section 38, a coefficient-generation section 39, the sound-directivity-generation section 40, the scanning-processing section 41, and the vector-synthesis section 42 perform predetermined processing in synchronization with one another, and the vector-synthesis section 42 performs processing that will be described later for the directional-stream signal. Subsequently, data on vector directions, namely, data on an FRT vector, an FL vector, an FR vector, an RL vector, an RR vector, and an LF scalar that are shown in FIG. 18 is input to an encoder-processing section 43 provided in the following stage, as an FRT signal, an FL signal, an FR signal, an RL signal, an RR signal, and an LF signal. The FL signal, the FR signal, the RL signal, the RR signal, and the LF signal are subjected to encode processing conforming to a known surround system, and recorded by a recording-and-reproduction section 44 such as a video disk, as record-stream signals.

According to the configuration shown in FIG. 1, an audio signal transmitted from the microphone and a video signal may be recorded at the same time. However, the video-signal recording will not be shown or described, since the video-signal recording is not directly related to the point of the above-described embodiment.

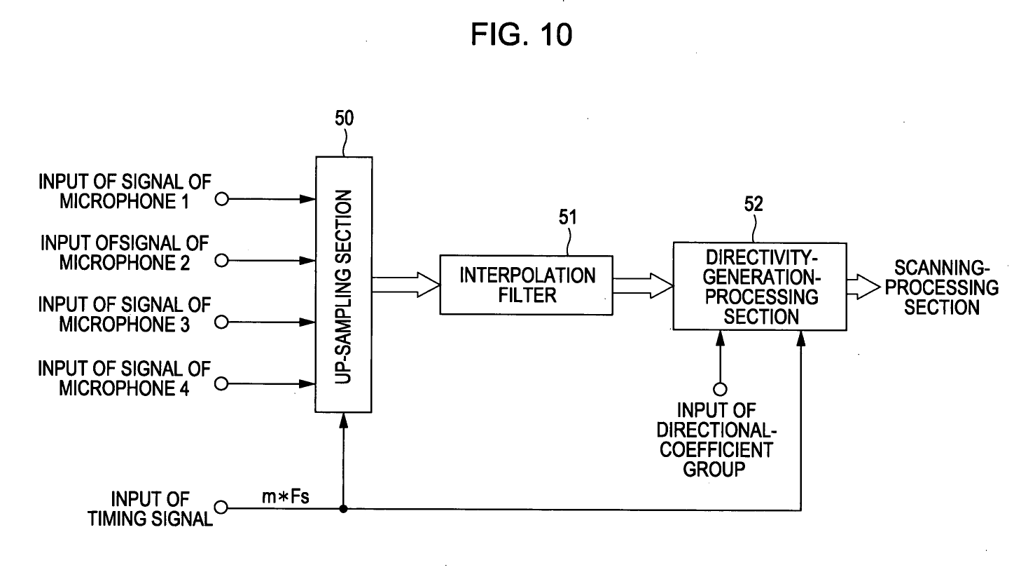

FIG. 10 shows supplementary information about the sound-directivity-generation section 40. According to the above-described embodiment, up-sampling processing is performed, so as to generate directional signals in a plurality of directions over a single audio-sampling period. The up-sampling processing is performed to increase the sampling rate. The up-sampling processing may be performed in an analog-to-digital converter (ADC) which is not shown, for example. However, the above-described signal is up-sampled to the frequency (m·Fs), for example.

First, a microphone-1 signal, a microphone-2 signal, a microphone-3 signal, and a microphone-4 signal that are sampled at the audio-sampling-frequency Fs are sampled again to the sampling frequency (m·Fs) which is necessary by an up-sampling section 50. At that time, an unnecessary wideband component is generated and removed by an interpolation filter 51 provided in the next stage, whereby the microphone-1 signal, the microphone-2 signal, the microphone-3 signal, and the microphone-4 signal are up-sampled, and directional signals in a plurality of directions are generated by a directivity-generation-processing section 52 including the directivity-generation device 1 shown in FIG. 4A, the directivity-generation device 2 shown in FIG. 6A, and so forth.

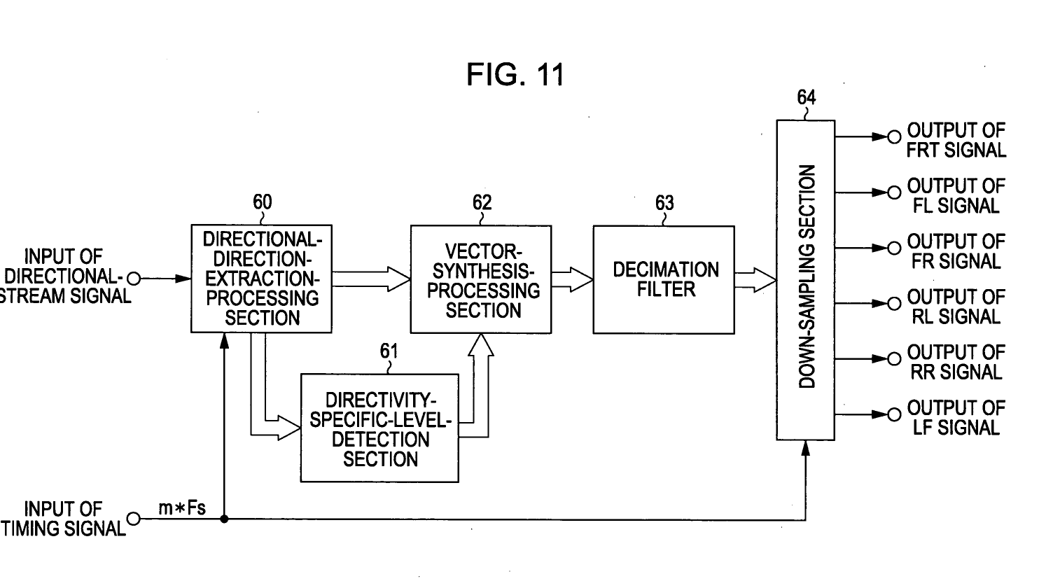

Further, FIG. 11 illustrates the vector-synthesis section 42 shown in FIG. 1. A directional-direction-extraction-processing section 60 extracts a directional signal necessary to perform vector-synthesis processing in the post stage from the directional-stream signal transmitted from the scanning-processing section 41 in the previous stage according to a timing signal synchronized with the sampling frequency (m*Fs) which is input separately. Then, the extracted directional signal is input to a directivity-specific-level-detection section 61 and a vector-synthesis-processing section 62 so that a vector is generated in a predetermined direction.

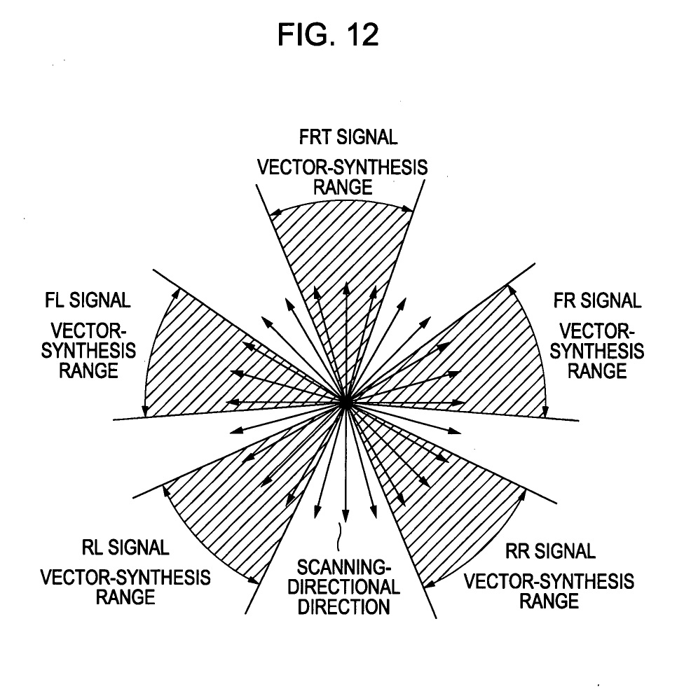

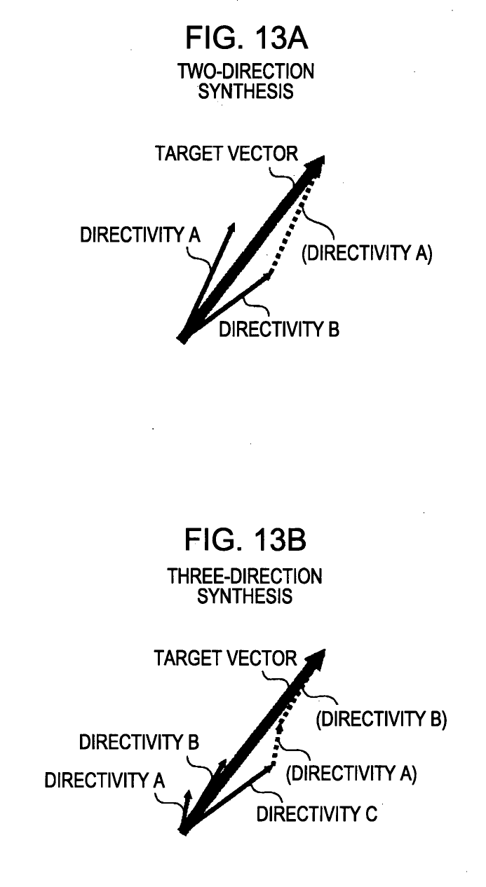

Here, each of FIGS. 12, 13A, and 13B illustrates the vector-synthesis-processing section 62 shown in FIG. 11. According to the above-described embodiment, a plurality of directional signals can be obtained in all circumferential directions. Therefore, it becomes possible to optimize the sound-pickup direction and the sound-pickup level according to the sound-pickup environment, a subject generating sound which is picked up, and reproduction conditions, and so forth. The above-described technology is different from known technologies in that the sound-pickup direction and the sound-pickup level can be optimized without fixing the sound-pickup direction.

First, the directional-direction-extraction-processing section 60 shown in FIG. 11 can extract any single direction from the plurality of directional directions, as required. However, according to the above-described embodiment, a vector is synthesized in a predetermined direction from a plurality of directional directions. Previously, sounds have been picked up in fixed directions, as shown in FIG. 18. In FIG. 12, however, the vector synthesis is performed within blacked-out ranges and in each of the above-described FRT direction, FL direction, FR direction, RL direction, and RR direction. The level of each of the plurality of directional signals extracted from the directional-direction-extraction-processing section 60 is detected by the directivity-specific-level-detection section 61. The vector-synthesis-processing section 62 synthesizes a target vector (shown by a solid line), as shown in FIG. 13A, for example, based on the directional signals A and B corresponding to two directions, and synthesizes another target vector (shown by a solid line), as shown in FIG. 13B, based on the directional signals A, B, and C corresponding to three directions.

Further, the above-described target vectors denote the directions of channels used during surround reproduction, for example, and the extraction directions and/or the ranges shown in FIG. 12 are exemplarily provided. For example, the FRT signal is extracted from a relatively large range, so as to clearly pick up the voice of a target subject including a child or the like. Further, for increasing the realism of a theme park or the like, the angle formed by the FL direction and the FR direction is made wider so that the extraction range in each of the directions is increased.

Further, in FIG. 11, a down-sampling section 64 down-samples the generated target-vector signal by multiplying the sampling rate by 1/m, which is the reverse of the up-sampling processing, so that the original sampling frequency Fs is obtained again. At that time, a decimation filter 63 removes an unnecessary alias component.

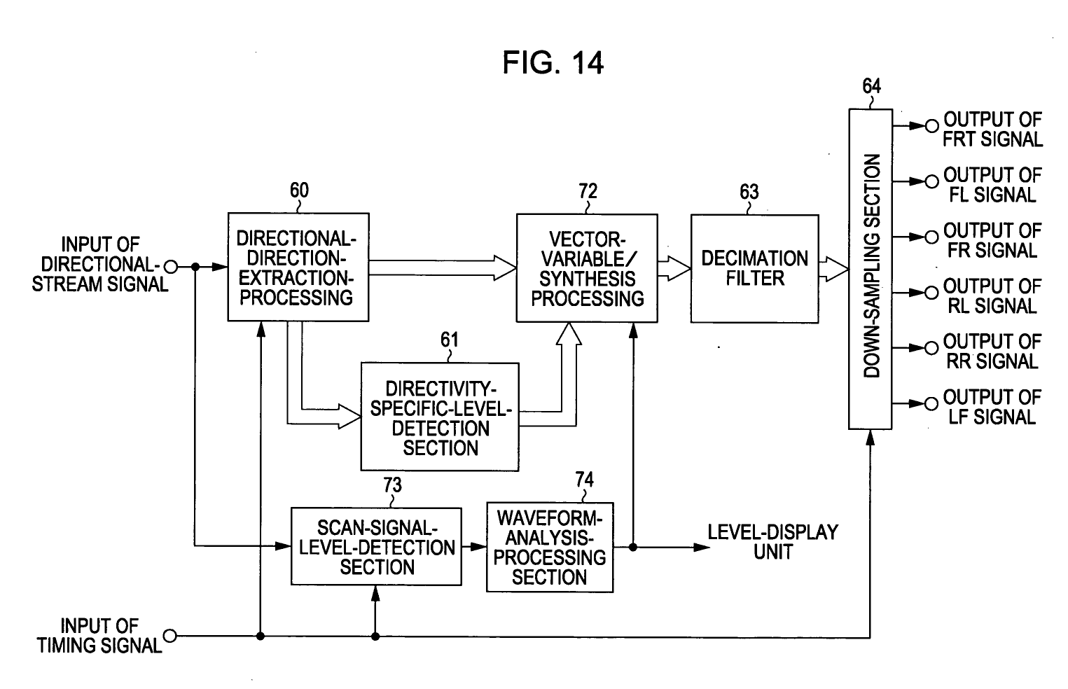

Next, a second example vector-synthesis section different from the vector-synthesis section 42 shown in FIG. 11 will be described with reference to FIG. 14. The same parts shown in FIG. 14 as those shown in FIG. 11 are designated by the same reference numbers and the detailed descriptions thereof will not be provided. Even though the scanning processing according to the above-described embodiment is not necessarily performed for the vector-synthesis section 42 shown in FIG. 11, the scanning processing is performed for the second example vector-synthesis section shown in FIG. 14, for example.

An input directional-stream signal is processed by the directional-direction-extraction-processing section 60, the directivity-specific-level-detection section 61, and a vector-variable/synthesis-processing section 72, as is the case with FIG. 11. Here, the above-described sections 60, 61, and 72 have the same functions as those of the sections shown in FIG. 11. However, the directional-stream signal is input to a scan-signal-level-detection section 73, which is different from the case described in FIG. 11. Here, when the directional-stream signal scanned in the rotation direction in the above-described manner is compared to a multi-channel sound signal which is picked up from a direction fixed for each of channels, as in the past manner, the information amount of the directional-stream signal is larger than that of the multi-channel sound signal, since the directional-stream signal includes a scanning-direction-level component.

Then, the level value of the above-described stream signal is continuously valued, whereby unprecedented effects can be obtained, as below.

1. The levels corresponding to all circumferential directions shown in FIG. 8 can be detected and displayed.

2. Information about the level-change rate, the level-maximum direction, the level-minimum direction, and so forth can be obtained by calculating a differential value (gradient) and the movement of the sound source can be grasped according to a change in the sound-source direction and the gradient.

3. An ambient sound-field environment can be estimated based on an integral value (whole power) and the above-described differential value. For example, it becomes possible to estimate that the whole power is relatively large and the level-maximum directions randomly exist in a theme park, the whole power is small and the level-minimum directions randomly exist in a relatively quiet environment, and so forth.

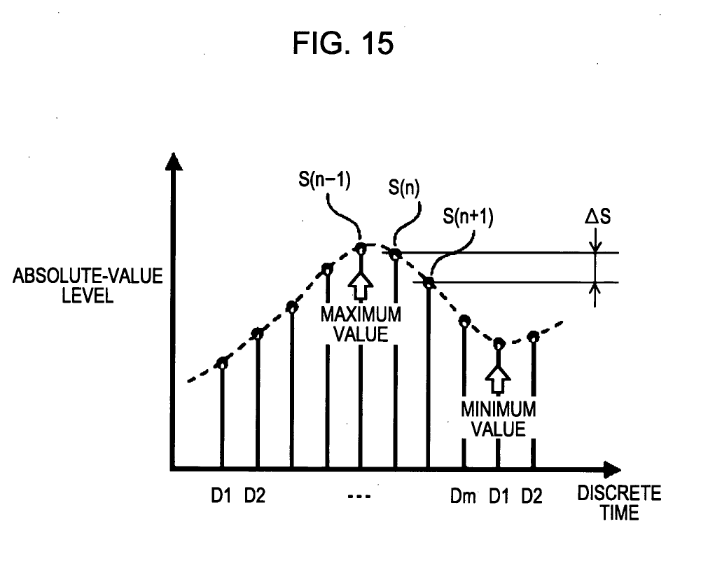

Here, the above-described scan-signal-level-detection section 73 and a waveform-analysis-processing section 74 will be described with reference to FIG. 15. The horizontal axis indicates a discrete time base, and the scan signals according to the above-described embodiment are input in sequence on a direction-by-direction basis. The vertical axis indicates the absolute-value level () obtained through the level detection. Therefore, the scan-signal-level-detection section 73 detects the scan-signal level continuously, as indicated by a broken line shown in FIG. 15, for example.

Then, in the waveform-analysis-processing section 74 provided in the post stage, the level values are output to a level-display unit so that the levels corresponding to all circumferential directions are displayed, as in the above-described first article. Further, when the level values S(n) and S(n+1) are detected, at any given time, ΔS is calculated, as shown by Equation (4).

ΔS=S(n+1)−S(n) (4)

The above-described ΔS approximates to the gradient of the tangent to a continuous level curve indicated by a broken line at any given time and corresponds to the differential value described in the above-described second article. Therefore, the value of ΔS can be determined by evaluating the ΔS continuously. Namely, when the value of ΔS varies, as shown by →0→−, it is determined that the maximum value of ΔS is attained. When the value of ΔS varies, as shown by →0→+, it is determined that the minimum value of ΔS is attained. Therefore, it becomes possible to immediately determine the direction of the maximum value corresponding to the maximum level and the opposite direction, namely, the direction of the minimum value corresponding to the minimum level. Further, when the values of the levels corresponding to all circumferential directions are added up and the integral value thereof is large, the sound level of the environment can be determined to be relatively high, and when the integral value is small, it can be determined that the environment is quiet.

An evaluation value other than the value of ΔS may be the size and steepness of the crest of the maximum value and the trough of the minimum value, the frequency of occurrence of the crest and the trough within a predetermined time period, and so forth. Further, information about the size and steepness of the crest of the maximum value the trough of the minimum value, the frequency of occurrence of the crest and the trough within the predetermined time period is output from the waveform-analysis-processing section 74 to the level-display unit, so as to detect and display the levels, as described in the above-described first article.

Upon receiving the above-described information, the waveform-analysis-processing section 74 outputs data on a variable coefficient used by the vector-variable/synthesis-processing section 72 provided in the post stage, so as to perform vector-variable processing. Then, the following vector-variable processing is performed, for example.

1. The central sound-pickup position (the photographer position) shown in a graphic-display image of all circumferential directions shown in FIG. 8 can be arbitrarily moved (panpod function) and the level balance is adjusted back and forth, and from side to side. Subsequently, sound-pickup processing and photographing can be performed with the optimized level balance.

2. When the level-maximum directions frequently occur in the photographing direction and the general sound level is relatively high, it can be determined that the subject ahead of the photographer generates sound. Therefore, the level of picking up the FRT signal, the FL signal, and the FR signal is increased, so as to make the sound more powerful.

3. When the level-maximum directions do not occur in a fixed direction, namely, when the level-maximum directions exist randomly, it can be determined that photographing is performed for subjects distributed in a wide area including a landscape, a theme park, and so forth. Therefore, the vector-synthesis area is increased in consideration of natural feelings of spread and linkage so that sounds are picked up in all directions evenly.

A user may perform the above-described processing arbitrarily by selecting mode at the photographing time. However, the variable-coefficient data transmitted from the waveform-analysis-processing section 74 may be generated automatically, as required, so that the vector-variable/synthesis-processing section 72 is controlled.

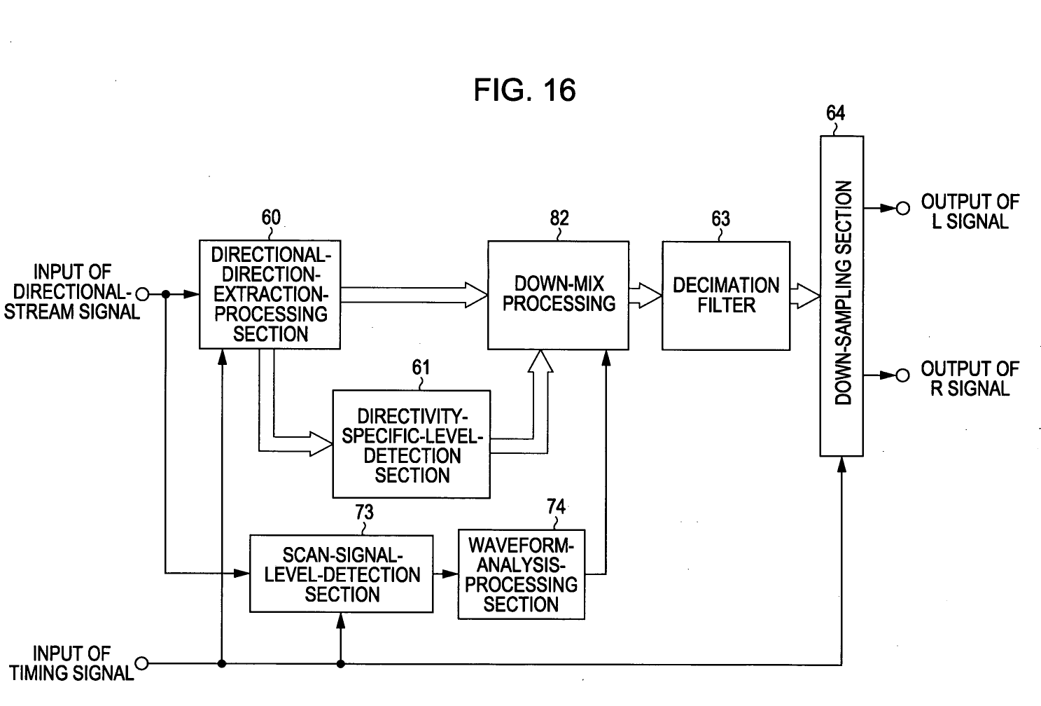

Further, the above-described embodiment can be used not only for the above-described surround outputting, but also for known stereo-2ch outputting, as shown in the third example vector-synthesis section shown in FIG. 16. The same parts shown in FIG. 16 as those shown in FIGS. 11 and 14 are designated by the same reference numbers and the detailed descriptions thereof will not be provided.

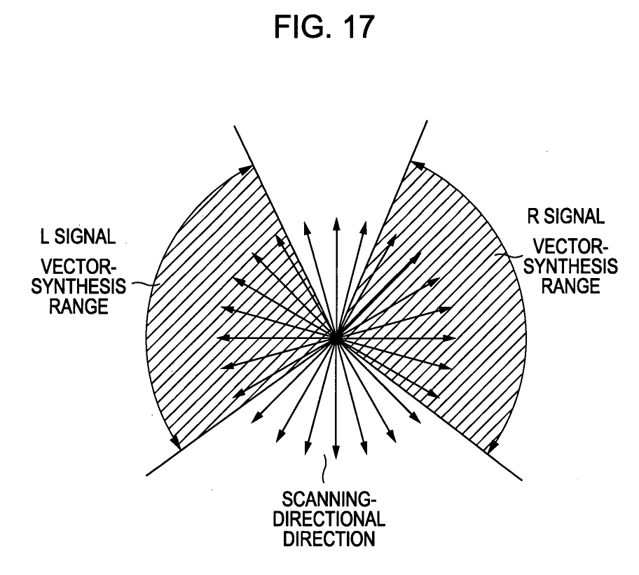

Namely, as is the case with FIG. 14, the directional-direction-extraction-processing section 60 extracts the signals corresponding to all circumferential directions from the transmitted directional stream signals, and the directivity-specific-level-detection section 61 detects the absolute-value level of each of the directional signals. Further, in a down-mix-processing section 82, a plurality of directional signals included in an Lch-side-vector-synthesis range (blacked-out) shown in FIG. 17, for example, and an Rch-side-vector-synthesis range (blacked-out) is synthesized, as required, as is the case with the example vector synthesis shown in FIGS. 13A and 13B. At that time, all of the signals included in the synthesis ranges may be synthesized so that vectors are constantly synthesized and output. However, the scan-signal-level-detection section 73 and the waveform-analysis-processing section 74 that are shown in FIG. 14 may evaluate the directional-stream signal, and the following processing procedures may be performed based on the evaluation result so that the level of the above-described vector synthesis can be varied.

1. The signal corresponding to the level-maximum direction is output at all times without fixing the direction in which a vector is synthesized within each of the Lch-side-vector-synthesis range and the Rch-side-vector-synthesis range, or the level of the signal corresponding to the level-maximum direction is increased, so that vectors are synthesized.

2. If the general sound power is low, the vector-synthesis range is increased so that a sound-pickup range is increased. On the contrary, when the sound power is high, the vector-synthesis range is decreased so that the sound-pickup level is equalized.

Subsequently, if the sound power is high and/or the level-maximum direction can be clearly identified, only the sound is emphasized. If the sound power is low and/or the level-maximum direction does not exist, the vector synthesis can be performed over a wide range. Therefore, both the sound articulation and a sense of realism can be achieved.

Further, the above-described embodiment may be performed not only in the sound-pickup operation and/or the record operation, but also in the operation where the above-described directional-stream signal and timing signal are recorded onto the recording-and-reproducing device and reproduced.

According to the above-described embodiment, when a multi-channel signal is generated for the above-described surround outputting in the sound-pickup operation, the sound-pickup processing is performed a number of times larger than the number of reproduction channels in all circumferential directions corresponding to from 1 degree to 360 degrees, and data on the picked-up sound is edited, as intended, according to the sound-field state and images at the photographing time. Subsequently, an effective surround-sound field can be obtained.

According to the above-described embodiment, a decreased number of microphones can be arranged closely. Therefore, the microphones can be mounted on a small device.

According to the above-described embodiment, it becomes easy to continuously generate the directional signals corresponding to all circumferential directions from signals output from the microphones that are arranged and fixed due to the given rotation coefficient.

According to the above-described embodiment, the scanning is performed repeatedly along the entire circumference in the rotation direction. Subsequently, it becomes possible to learn the surroundings with respect to sound, as a radar detector does, and the sound-pickup condition can be optimized according to data on the surroundings.

According to the above-described embodiment, the scanning is performed repeatedly over a predetermined range in the directions of reproduction channels used for a surround system, and vectors are synthesized based on information about the scanning result. Therefore, the disagreement between the sound field in the sound-pickup operation and the sound field at the reproduction time becomes less significant than that which occurs when sound is picked up from a fixed direction, as in the past manner.

According to the above-described embodiment, sound-pickup signals obtained from a plurality of directions are synthesized into a vector in a required sound-channel direction to achieve a surround-reproduction system based on the sound-pickup directions and the sound-pickup levels. Namely, the sound-pickup method used in the above-described embodiment is different from a known spot-sound-pickup method where sound is picked up from a single direction. Therefore, the sound-pickup system according to the above-described embodiment is hardly affected by the manner in which speakers are arranged at the data-reproduction time.

According to the above-described embodiment, details on the vector synthesis can be optimized according to a change in the surroundings based on level-change information obtained through the scanning processing performed in all circumferential directions. Details on the above-described change in the surroundings may be that a sound source such as a person exists ahead of the photographer, sound sources are distributed over a wide area, as is the case with a theme park, a sound generated by the photographer (narration sound) comes from the rear, and so forth.

According to the above-described embodiment, the differential value of the level changes obtained through the scanning processing performed in all circumferential directions (gradient and change rate) and the integral value (area and power) are calculated so that the direction in which the sound source-exists, the movement of the sound source, and the sound power can be determined.

According to the above-described embodiment, the directivities are synthesized as a vector in the sound-source direction determined based on the differential value and the integral value. Subsequently, a sound generated by the sound source can be clearly picked up.

The above-described embodiment can be used for the case where a sound signal is picked up and recorded along with video data captured by a video camera or the like.

The above-described embodiment can be performed not only in the sound-pickup operation and/or the sound-recording time, but also at the time where sound data is reproduced from the recording-and-reproduction device (not shown). In that case, the sound data can be reproduced in the most appropriate manner for the reproduction conditions. Namely, the sound data can be reproduced according to the speaker-arrangement directions.

It should be understood by those skilled in the art that various modifications, combinations, sub-combinations and alterations may occur depending on design requirements and other factors insofar as they are within the scope of the appended claims or the equivalents thereof.

What is claimed is:

1. A sound-pickup device comprising:
input means configured to input a plurality of sound signals;
sound-directivity-generation means configured to generate a plurality of sound-directional signals in all circumferential directions from the sound signals;
scanning means configured to scan and output the sound-directional signals in order of directivity directions; and
vector-synthesis means configured to select at least one specified-direction signal transmitted from the scanning means and synthesize a specified direction,
wherein at least one signal output from the vector-synthesis means is processed to be a plurality of sound-output channels.

2. The sound-pickup device according to claim 1, wherein the input means includes:
a first bidirectional microphone having a bidirectional directivity in a predetermined direction;
a second bidirectional microphone having another bidirectional directivity in a direction perpendicular to the predetermined direction; and
a non-directional microphone having no directivity.

3. The sound-pickup device according to claim 1, wherein the input means includes four non-directional microphones having no directivity, the non-directional microphones being provided on vertexes of a quadrilateral, where a straight line establishing a link between two of the vertexes opposite to one another is perpendicular to a straight line establishing a link between the other two of the vertexes.

4. The sound-pickup device according to claim 1, wherein the input means includes:
a first directional microphone having a directivity in a predetermined direction;
a second directional microphone having another directivity in a direction opposite to the predetermined direction; and
a bidirectional microphone having a bidirectional directivity in a direction perpendicular to the predetermined direction.

5. The sound-pickup device according to claim 1, wherein the sound-directivity-generation means includes:
an addition-and-synthesis unit configured to add and synthesize output signals transmitted from a first bidirectional microphone, a second bidirectional microphone, and a non-directional microphone, the output signals being transmitted from the input means according to claim 2; and
addition-and-synthesis-unit-level-adjustment means configured to adjust and output a level of the addition-and-synthesis unit according to a sound-directivity-generation direction.

6. The sound-pickup device according to claim 1, wherein the sound-directivity-generation means includes:
addition means configured to generate a non-directional signal by adding at least two arbitrary output signals of output signals of four non-directional microphones, the output signals being transmitted from the input means, according to claim 3;
subtraction means configured to generate two bidirectional signals by performing a subtraction between output signals that are opposite to each other of the output signals of the four non-directional microphones;
an addition-and-synthesis unit configured to add and synthesize the non-directional signal and the bidirectional signal; and
addition-and-synthesis-unit-level-adjustment means configured to adjust and output a level of the addition-and-synthesis unit according to a sound-directivity-generation direction.

7. The sound-pickup device according to claim 1, wherein the sound-directivity-generation means includes:
an addition-and-synthesis unit configured to add and synthesize output signals of first and second directional microphones, and a bidirectional microphone, the output signals being transmitted from the input means according to claim 4; and
addition-and-synthesis-unit-level-adjustment means configured to adjust and output a level of the addition-and-synthesis unit according to a sound-directivity-generation direction.

8. The sound-pickup device according to claim 1, wherein the scanning means performs scanning by rotating continuously in a predetermined rotation direction.

9. The sound-pickup device according to claim 1, wherein the scanning means performs scanning continuously over a predetermined direction range for each of the sound-output channels.

10. The sound-pickup device according to claim 1, wherein the vector-synthesis means includes directivity-direction-level-detection means configured to detect a level value of each of the directivity directions and synthesizes a vector over a predetermined-direction range based on level information transmitted from the directivity-direction-level-detection means and a directivity-center direction for each of the sound-output channels in a target direction of each of the sound-output channels.

11. The sound-pickup device according to claim 1, wherein the vector-synthesis means includes:
directivity-direction-level-detection means configured to detect the level value corresponding to each of the directivity directions;
scanning-direction-level-detection means configured to continuously detect the level value corresponding to a scanning direction;
analysis means configured to analyze data on a level change, the level-change data being transmitted from the scanning-direction-level-detection means; and
parameter-variable means provided to vary a parameter during vector-synthesis time,
wherein the vector-synthesis means synthesizes a vector while varying the parameter by using the parameter-variable means based on level information transmitted from the directivity-direction-level-detection means and a directivity-center direction for each of the sound-output channels in a target direction of each of the sound-output channels.

12. The sound-pickup device according to claim 11, wherein the analysis means analyzes a differential value and/or an integral value of a time-to-level function.

13. The sound-pickup device according to claim 11, wherein the parameter-variable means varies a vector-extraction-direction range and/or every vector level, as the parameter.

14. A sound-pickup device comprising:
input means configured to input a plurality of sound signals relating to a signal of shot video;
sound-directivity-generation means configured to generate a plurality of sound-directional signals in all circumferential directions from the sound signals;
scanning means configured to scan and output the sound-directional signals in order of directivity directions; and
vector-synthesis means configured to select at least one specified-direction signal transmitted from the scanning means and synthesize a specified direction,
wherein at least one signal output from the vector-synthesis means is processed to be a plurality of sound-output channels.

15. A sound-pickup device comprising:
reproduction means configured to reproduce a plurality of sound-directional signals;
scanning means configured to scan and output the sound-directional signals in order of directivity directions; and
vector-synthesis means configured to select at least one specified-direction signal transmitted from the scanning means and synthesize a specified direction,
wherein at least one signal output from the vector-synthesis means is processed to be a plurality of sound-output channels.

16. A sound-pickup method comprising the steps of:
inputting a plurality of sound signals;
generating a plurality of sound-directional signals in all circumferential directions from the sound signals;
scanning and outputting the sound-directional signals in order of directivity directions; and
selecting at least one specified-direction signal obtained through the scanning step and synthesizing a plurality of specified direction, as vectors,
wherein at least one output signal obtained through the vector-synthesis step is processed to be a plurality of sound-output channels.

17. A sound-pickup method comprising the steps of:
inputting a plurality of sound signals relating to a signal of shot video;
generating a plurality of sound-directional signals in all circumferential directions from the sound signals;
scanning and outputting the sound-directional signals in order of directivity directions; and
selecting at least one specified-direction signal obtained through the scanning step and synthesizing a specified direction, as a vector,
wherein at least one output signal obtained through the vector-synthesis step is processed to be a plurality of sound-output channels.

18. A sound-pickup method comprising the steps of:
reproducing a plurality of sound-directional signals;
scanning and outputting the sound-directional signals in order of directivity directions; and
selecting at least one specified-direction signal obtained through the scanning step and synthesizing a specified direction, as a vector,
wherein at least one output signal obtained through the vector-synthesis step is processed to be a plurality of sound-output channels.

19. A sound-pickup device comprising:
an input unit configured to input a plurality of sound signals;
a sound-directivity-generation unit configured to generate a plurality of sound-directional signals in all circumferential directions from the sound signals;
a scanning unit configured to scan and output the sound-directional signals in order of directivity directions; and
a vector-synthesis unit configured to select at least one specified-direction signal transmitted from the scanning unit and synthesize a specified direction,
wherein at least one signal output from the vector-synthesis unit is processed to be a plurality of sound-output channels.

20. A sound-pickup device comprising:
an input unit configured to input a plurality of sound signals relating to a signal of shot video;
a sound-directivity-generation unit configured to generate a plurality of sound-directional signals in all circumferential directions from the sound signals;
a scanning unit configured to scan and output the sound-directional signals in order of directivity directions; and
a vector-synthesis unit configured to select at least one specified-direction signal transmitted from the scanning unit and synthesize a specified direction,
wherein at least one signal output from the vector-synthesis unit is processed to be a plurality of sound-output channels.

21. A sound-pickup device comprising:
a reproduction unit configured to reproduce a plurality of sound-directional signals;
a scanning unit configured to scan and output the sound-directional signals in order of directivity directions; and
a vector-synthesis unit configured to select at least one specified-direction signal transmitted from the scanning unit and synthesize a specified direction,
wherein at least one signal output from the vector-synthesis unit is processed to be a plurality of sound-output channels.
